(19) United States
(12) Patent Application Publication
(10) Pub. No.: US 2024/0319139 A1
(43) Pub. Date: Sep. 26, 2024

(54) CHEMICAL SENSOR SYSTEM

(71) Applicant: KABUSHIKI KAISHA TOSHIBA, Tokyo (JP)

(72) Inventor: Yoshiaki SUGIZAKI, Fujisawa Kanagawa (JP)

(73) Assignee: KABUSHIKI KAISHA TOSHIBA, Tokyo (JP)

(21) Appl. No.: 18/484,684

(22) Filed: Oct. 11, 2023

(30) Foreign Application Priority Data
Mar. 22, 2023 (JP) 2023-045029

(51) Int. Cl. G01N 29/036; G01N 27/00

(52) U.S. Cl. CPC G01N 29/036; G01N 27/007; G01N 2291/0257

(57) ABSTRACT

A chemical sensor system includes a chemical sensor including a sensor element and a probe molecule located on a surface of the sensor element; a collection unit for a sample atmosphere; a humidification device configured to generate a humidification fluid having a humidity higher than a humidity of the sample atmosphere; a switching mechanism connected to the collection unit, the humidification device, and the chemical sensor, the switching mechanism configured to switch between a state in which the sample atmosphere is supplied to the surface of the sensor element and a state in which the humidification fluid is supplied to the surface of the sensor element; and a cooling mechanism configured to cool the sensor element.

### CROSS-REFERENCE TO RELATED APPLICATION

This application is based upon and claims the benefit of priority from Japanese Patent Application No. 2023-045029, filed on Mar. 22, 2023; the entire contents of which are incorporated herein by reference.

### FIELD

Embodiments described herein relate generally to a chemical sensor system.

### BACKGROUND

In a chemical sensor that detects a target substance in a gas phase, an improvement in sensitivity is required.

### BRIEF DESCRIPTION OF THE DRAWINGS

FIG. 1 is a schematic diagram showing a configuration of a chemical sensor system of an embodiment;

FIG. 2A is a schematic view of a sensor element of the embodiment, and FIG. 2B is a schematic view of a surface of the sensor element;

FIG. 3 is a schematic view of a chemical sensor and a cooling mechanism of the embodiment;

FIG. 4 is a schematic view showing another example of the cooling mechanism of the embodiment;

FIG. 5 to FIG. 12 are diagrams showing experimental results; and

FIG. 13 and FIG. 14 are schematic diagrams showing a configuration of a chemical sensor system used in an experiment.

### DETAILED DESCRIPTION

According to one embodiment, a chemical sensor system includes a chemical sensor including a sensor element and a probe molecule located on a surface of the sensor element; a collection unit for a sample atmosphere; a humidification device configured to generate a humidification fluid having a humidity higher than a humidity of the sample atmosphere; a switching mechanism connected to the collection unit, the humidification device, and the chemical sensor, the switching mechanism configured to switch between a state in which the sample atmosphere is supplied to the surface of the sensor element and a state in which the humidification fluid is supplied to the surface of the sensor element; and a cooling mechanism configured to cool the sensor element.

Hereinafter, an embodiment will be described with reference to the drawings. In the drawings, the same configurations are denoted by the same reference numerals.

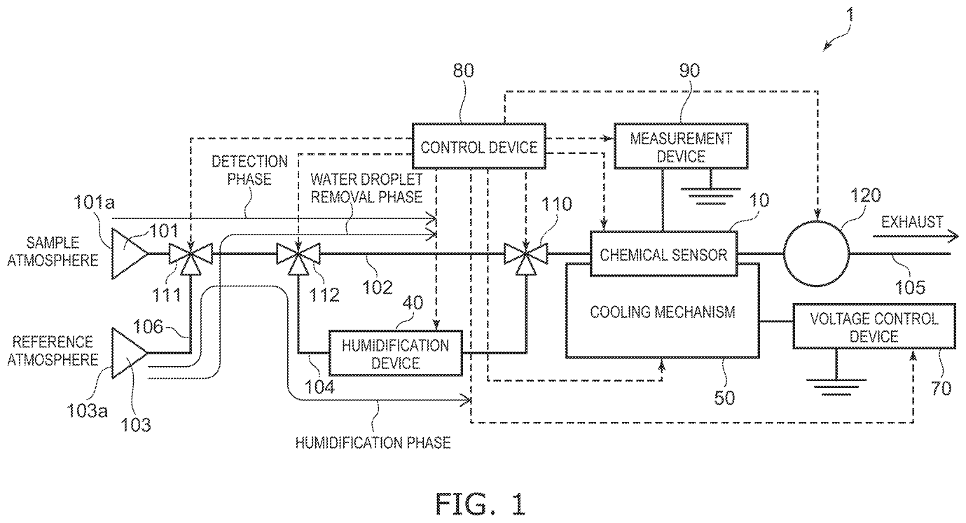

As shown in FIG. 1, a chemical sensor system 1 of the embodiment includes a first collection unit 101 into which a sample atmosphere is collected, and a chemical sensor 10. The chemical sensor system 1 may further include, for example, a first pipe 102 as a mechanism for supplying the chemical sensor 10 with the sample atmosphere collected from the first collection unit 101, an exhaust pipe 105, and an exhaust device 120. The sample atmosphere is, for example, air.

The first pipe 102 is connected between the first collection unit 101 and the chemical sensor 10. The chemical sensor 10 is connected between the first pipe 102 and the exhaust pipe 105. The exhaust device 120 is connected to the exhaust pipe 105. The exhaust device 120 is, for example, a fan. The first collection unit 101 includes a first collection port 101a that opens to an outside of the first pipe 102. By driving the exhaust device 120, a gas flow from the first collection port 101a to the exhaust pipe 105 through the first pipe 102 and the chemical sensor 10 is formed. The exhaust device 120 may be an air pump.

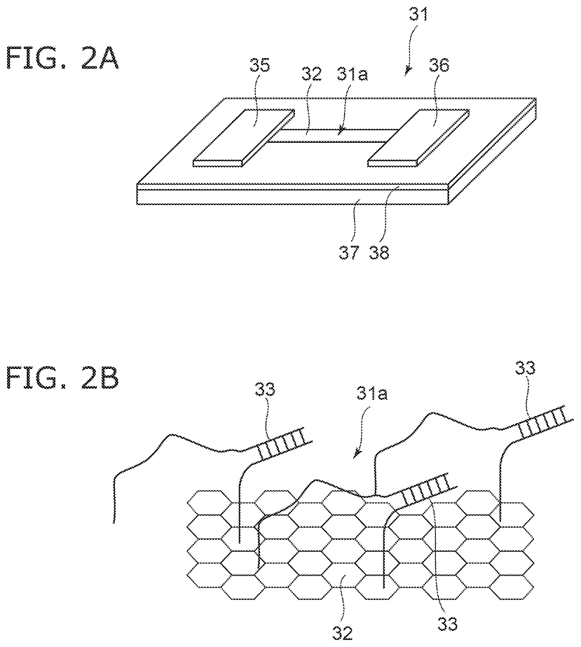

The chemical sensor 10 includes a sensor element 31 shown in FIG. 2A. The sensor element 31 has, for example, a graphene field effect transistor (GFET) structure, and a surface 31a of the sensor element 31 contains graphene. For example, the sensor element 31 may include a substrate 37, graphene 32 supported on the substrate 37, a first electrode 35, and a second electrode 36.

The substrate 37 is, for example, a silicon substrate. For example, the graphene 32 is provided above the substrate 37 via a foundation film 38. Examples of the foundation film 38 include a silicon oxide film. Further, the foundation film 38 may have a function of a chemical catalyst for forming the graphene 32.

One of the first electrode 35 and the second electrode 36 functions as a drain electrode, and the other functions as a source electrode. The first electrode 35 and the second electrode 36 are in electrical contact with the graphene 32. A current (a drain current) flows between the first electrode 35 and the second electrode 36 through the graphene 32. The chemical sensor system 1 may include a measurement device 90 (shown in FIG. 1) that measures the drain current.

As shown in FIG. 2B, the chemical sensor 10 has probe molecules 33 located on the surface 31a of the sensor element 31. The probe molecules 33 being located on the surface 31a of the sensor element 31 means that the probe molecules 33 are bound, adsorbed, or contiguous to the surface 31a of the sensor element 31, for example, chemically or by charge-induced attraction, n-n interaction, cation-n interaction, or hydrophobic interaction, and the probe molecules 33 are constrained on the surface 31a of the sensor element 31. Examples of the probe molecules 33 include any substance exhibiting a binding property to a target substance, such as a protein, a peptide, an antibody, a DNA aptamer, and derivatives thereof.

When the probe molecules 33 recognize or capture the target substance, since the target substance is contiguous to the surface of the graphene 32, an electronic state of the graphene 32 changes according to electric charges of the target substance or a structural change of the probe molecules 33 caused by capturing the target substance. By detecting the change in the electronic state as a change in the current (drain current) flowing between the first electrode 35 and the second electrode 36, presence and concentration of the target substance in the sample atmosphere can be known.

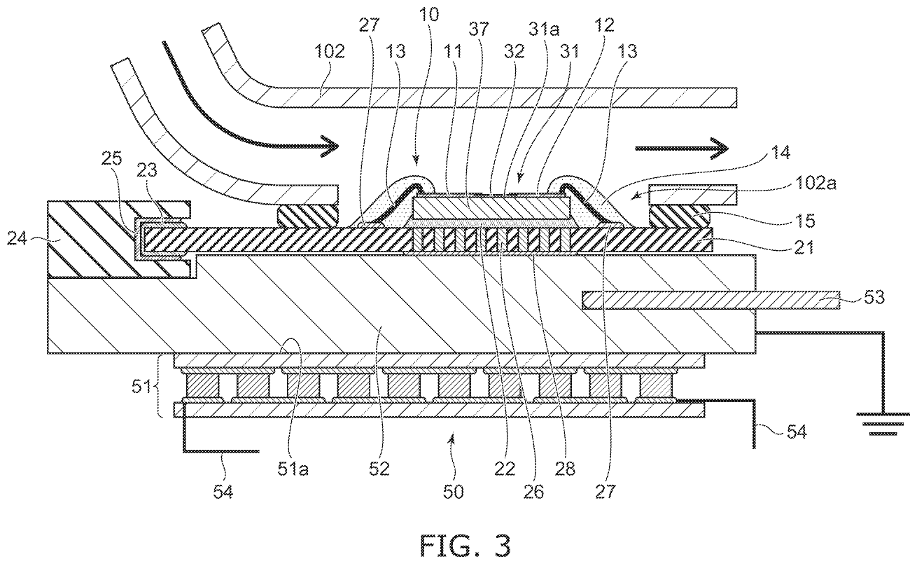

As shown in FIG. 3, the sensor element 31 can be mounted on a cartridge substrate 21. The substrate 37 of the sensor element 31 is bonded to a surface of the cartridge substrate 21 by, for example, a thermal conduction adhesive 22. An input and output terminal 23 is provided at one end of the cartridge substrate 21. The one end of the cartridge substrate 21 is inserted into a socket 24, and the input and output terminal 23 is electrically connected to an electrode 25 provided in the socket 24. The socket 24 is electrically connected to the measurement device 90 shown in FIG. 1.

A first wiring 11 electrically connected to the first electrode 35 and a second wiring 12 electrically connected to the second electrode 36 are provided on the substrate 37 of the sensor element 31. The first wiring 11 and the second wiring 12 are electrically connected to wiring units 27 provided on the cartridge substrate 21 via gold wires 13, respectively. The wiring units 27 are electrically connected to the input and output terminal 23. The gold wires 13, a bonding portion between the gold wire 13 and the first wiring 11, a bonding portion between the gold wire 13 and the second wiring 12, and bonding portions between the gold wires 13 and the wiring units 27 are covered and protected by an insulation resin 14.

A window 102a is opened in a sensor element disposition unit of the first pipe 102, and a packing 15 is provided on an outer periphery of the window 102a. When the sensor element 31 mounted on the cartridge substrate 21 is located in the window 102a, the surface 31a of the sensor element 31 is airtightly shielded from an outside by the packing 15 and exposed in the first pipe 102. With such a configuration, the sensor element 31 can be attached and detached as a replacement part or a consumable part.

The chemical sensor system 1 further includes a cooling mechanism 50 that cools the sensor element 31. In an example shown in FIG. 3, the cooling mechanism 50 includes a Peltier element 51 and a regenerator 52 in contact with a surface (heat absorbing surface) 51a of the Peltier element 51.

The Peltier element 51 is electrically connected to drive wirings 54. The regenerator 52 has thermal conductivity and electrical conductivity. Examples of a material for the regenerator 52 include Al and Cu. The regenerator 52 is fixed to, for example, a ground potential via a voltage control device 70 shown in FIG. 1 as necessary. Further, a temperature of the regenerator 52 is detected by a thermocouple 53, and a detection result thereof can be fed back to driving of the Peltier element 51.

The regenerator 52 is disposed between the cartridge substrate 21 and the Peltier element 51. A lower surface of the regenerator 52 is in contact with the surface 51a of the Peltier element 51. An upper surface of the regenerator 52 is in contact with a thermal conduction member 28 provided on a lower surface of the cartridge substrate 21. The thermal conduction member 28 is connected to multiple thermal conduction vias 26 penetrating the cartridge substrate 21. As the thermal conduction member 28, for example, a high thermal conduction sheet containing carbon, metal, and ceramic powder, or thermal grease may be used. Examples of a material for the thermal conduction vias 26 include a substrate wiring material such as Cu 20 plating, and a high thermal conduction paste containing metal and ceramic powder.

A thermal conduction path formed by the regenerator 52, the thermal conduction member 28, the thermal conduction vias 26, and the thermal conduction adhesive 22 is formed between the surface 51a of the Peltier element 51 and the sensor element 31.

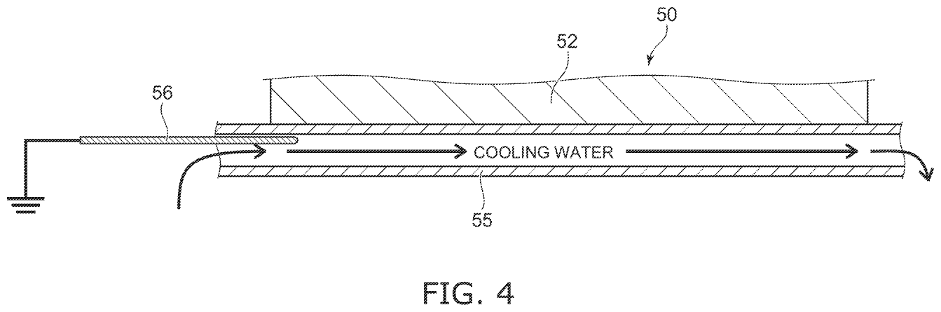

As shown in FIG. 4, the cooling mechanism 50 may include a cooling pipe 55 that is in contact with the lower surface of the regenerator 52 and through which cooling water flows, and a non-polarizable electrode 56 at least a part of which is located in the cooling pipe 55.

The non-polarizable electrode 56 is electrically connected to the voltage control device 70 shown in FIG. 1. The non-polarizable electrode 56 comes into contact with the cooling water flowing in the cooling pipe 55 to fix a potential of the cooling water. For example, cooling water containing chlorine ions flows in the cooling pipe 55, and the non-polarizable electrode 56 is an Ag/AgCl electrode.

As shown in FIG. 1, the chemical sensor system 1 further includes a humidification device 40 that generates a humidification fluid having a humidity higher than that of the sample atmosphere. The humidification fluid is, for example, humidified air or humidified nitrogen. Examples of the humidification device 40 include an impinger in which a humidification source is placed, a pipe in which a nonwoven fabric wet by the humidification source is attached to an inner wall thereof, and a bubbling device or a spraying device. The humidification device 40 is a device for increasing vapor pressure of a predetermined substance contained in a fluid. The predetermined substance is, for example, a substance that is hydrophilic or amphipathic and is bonded to probe molecules. For example, the predetermined substance does not modify the probe molecule and maintains a three-dimensional structure of the probe molecules in a desirable shape. The predetermined substance is, for example, a substance that exhibits volatility in a liquid or gas at normal temperature and pressure. In addition to water, the predetermined substance may be a carbonyl compound such as acetone, or alcohol such as methanol or ethanol.

The chemical sensor system 1 includes switching mechanisms 110 to 112 connected to the first collection unit 101, the first pipe 102, the humidification device 40, and the chemical sensor 10. In the first pipe 102, the switching mechanism 111 is located between the first collection unit 101 and the switching mechanism 112, the switching mechanism 112 is located between the switching mechanism 111 and the switching mechanism 110, and the switching mechanism 110 is located between the switching mechanism 112 and the chemical sensor 10. Examples of the switching mechanisms 110 to 112 include a ball valve.

The humidification device 40 is connected to a second pipe 104. An upstream end of the second pipe 104 is connected to the switching mechanism 112, and a downstream end of the second pipe 104 is connected to the switching mechanism 110.

Further, a second collection unit 103 can be connected to the switching mechanism 111 via a third pipe 106. For example, a reference atmosphere at a position away from the sample atmosphere can be collected into the third pipe 106 from a second collection port 103a of the second collection unit 103. By switching the switching device 111 and the switching device 112 to a state of connecting the third pipe 106 and the second pipe 104 and switching the switching device 110 to a state of connecting the second pipe 104 and the chemical sensor 10, the reference atmosphere can be humidified by the humidification device 40 and the humidification fluid humidified by the humidification device 40 can be supplied to the chemical sensor 10.

That is, by switching the switching mechanisms 110 to 112, a state (a detection phase) in which the sample atmosphere is supplied to the surface of the sensor element 31 and a state (humidification phase) in which the humidification fluid is supplied to the surface of the sensor element 31 can be switched. During the detection phase, the humidification fluid is not supplied to the surface of the sensor element 31. During the humidification phase, the sample atmosphere is not supplied to the surface of the sensor element 31.

Further, by switching the switching mechanisms 110 to 112, a condensation removal phase in which the reference atmosphere is supplied to the chemical sensor 10 without passing through the humidification device 40 can be executed.

The chemical sensor system 1 may further include a control device 80. The control device 80 can control the humidification device 40, the switching mechanisms 110 to 112, the measurement device 90, the chemical sensor 10, the fan 120, the cooling mechanism 50, and the voltage control device 70.

Under the control of the control device 80, after the humidification phase is executed for a predetermined time in advance, the humidification phase is stopped, and processing proceeds to the condensation removal phase as necessary. After the condensation removal phase is executed for a predetermined time, the processing proceeds to the detection phase, and the target substance in the sample atmosphere is detected. In the humidification phase, the probe molecules 33 located on the surface of the sensor element 31 are humidified, and the probe molecules 33 can be activated. Accordingly, an ability of the probe molecules 33 to capture the target substance is improved, and detection sensitivity of the target substance can be improved. Since formation of water droplets due to condensation in the humidification phase causes noise, the water droplets are removed in the condensation removal phase. In the condensation removal phase (a water droplet removal phase), the water droplets are vaporized and removed, but since hydrophilic portions of the probe molecules 33 are maintained in a humidified state, the capturing ability can be exhibited.

In the embodiment, the sample atmosphere itself is not humidified, the surface of the sensor element 31 is humidified in advance before the detection phase, and the sample atmosphere which is not humidified is supplied to the surface of the sensor element 31 in the detection phase. Accordingly, as shown in experimental results to be described later, the detection sensitivity of the target substance can be improved as compared with a case where the sample atmosphere is humidified and supplied to the surface of the sensor element 31 in the detection phase.

Further, when the sensor element 31 is cooled by the cooling mechanism 50, a temperature of the sample atmosphere supplied to the surface of the sensor element 31 is lowered, and the target substance is easily adsorbed on the surface (including the probe molecules 33) of the sensor element 31. Accordingly, the detection sensitivity of the target substance can be further improved.

By the cooling, a substance supplied in the humidification phase, for example, water can be prevented from evaporating from the sensor element 31. By the cooling, detachment of water bound to the probe molecules 33 is prevented, and a three-dimensional structure of the probe molecules 33 is maintained. Accordingly, a state in which the binding property of the probe molecules 33 to the target substance is high is maintained for a long time.

In addition, by fixing a potential of the regenerator 52 or the potential of the cooling water, stable detection with reduced noise due to a potential variation thereof can be performed. Next, the experimental results will be described. In the following experiments, a GFET was used as the sensor element. 9-residue peptide was used as the probe molecule. The peptide has a sequence of RRWLPLWRR-GGGC, and a first 9-residue is a probe site. GGG is a spacer sequence, and C is a linker site for binding to a maleic group of a scaffold molecule.

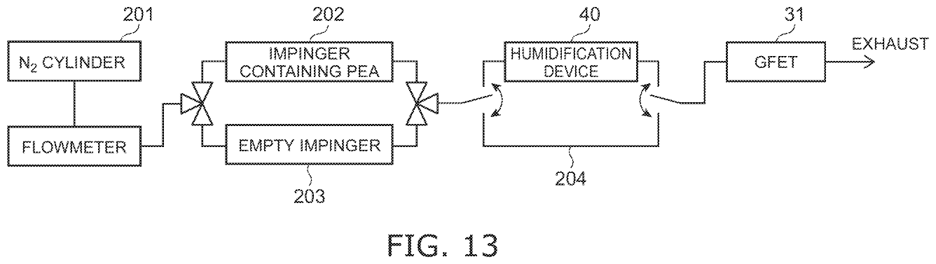

FIG. 13 is a schematic diagram showing a configuration of a system used in the experiments. Between a cylinder 201 of nitrogen gas (N₂ gas) and a GFET 31, an empty impinger 203 was connected with an impinger 202 containing the target substance, and a state in which the nitrogen gas was supplied to the GFET 31 via the impinger 202 containing the target substance and a state in which the nitrogen gas was supplied to the GFET 31 via the empty impinger 203 were switched. In graphs of the drawings to be shown below, a horizontal axis represents time (minutes), and a vertical axis represents the drain current (relative value) of the GFET.

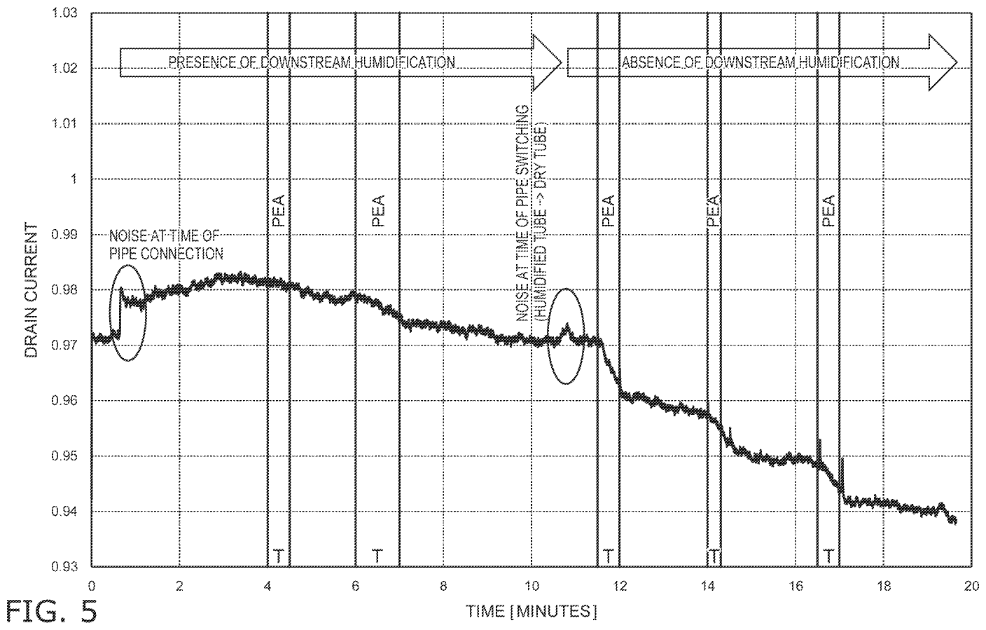

In the experiment whose results are shown in FIG. 5, phenylethylamine (PEA) was used as the target substance. In the state in which the nitrogen gas was supplied to the GFET 31 via the empty impinger 203, the nitrogen gas was supplied to the GFET 31 via an impinger containing the PEA during times T. In FIG. 5, “presence of downstream humidification” indicates a state in which the nitrogen gas is supplied to the GFET 31 in a state in which the humidification device 40 is connected downstream of the impinger 202 containing the PEA and the empty impinger 203. A non-woven fabric containing water is provided in the humidification device 40. “Absence of downstream humidification” indicates a state in which the nitrogen gas is supplied to the GFET 31 via a drying tube 204 from the impinger 202 containing the PEA and the empty impinger 203 without passing through the humidification device 40. Connection between the humidification device 40 and the impinger 202 and connection between the humidification device 40 and the impinger 203 were manually switched. Further, connection between the GFET 31 and the humidification device 40 and connection between the GFET 31 and the drying tube 204 were also manually switched.

From a result of FIG. 5, it can be seen that a response of the drain current at the times T is larger in the “absence of downstream humidification” than in the “presence of downstream humidification”, that is, the detection sensitivity of the PEA is higher. In a case of the “presence of downstream humidification”, the nitrogen gas containing the humidified PEA is supplied to the GFET. When water is vaporized in the nitrogen gas containing the PEA, partial pressure of water vapor in total pressure of the gas increases, and a conflict between the partial pressure of the PEA and vapor pressure occurs. However, it is considered that since the PEA has no new evaporation source, only the partial pressure of the water increases, and as a result, a part of the PEA liquefies and the partial pressure decreases, which decreases the detection sensitivity of the PEA.

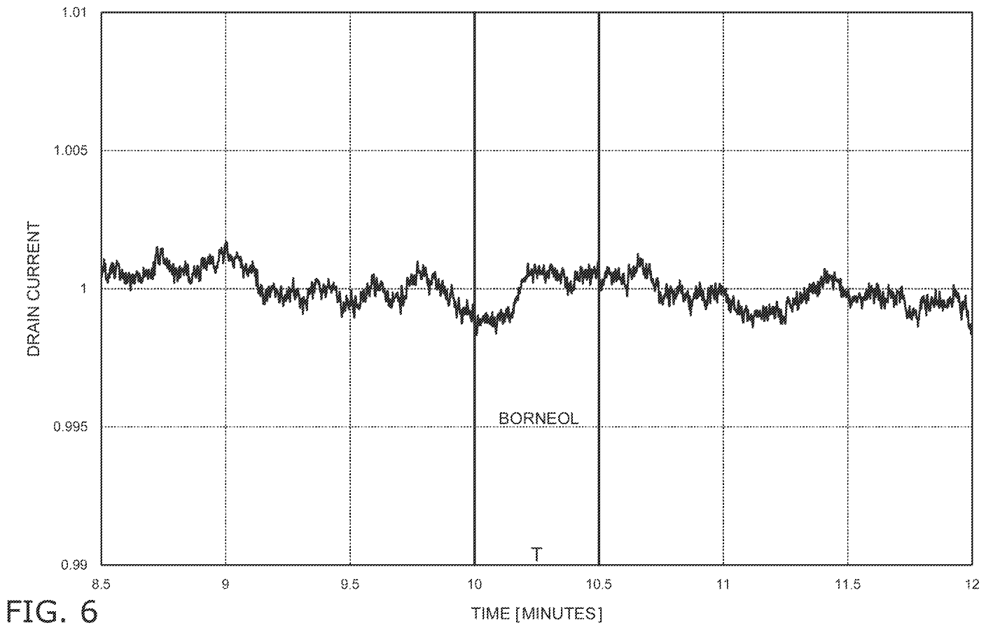

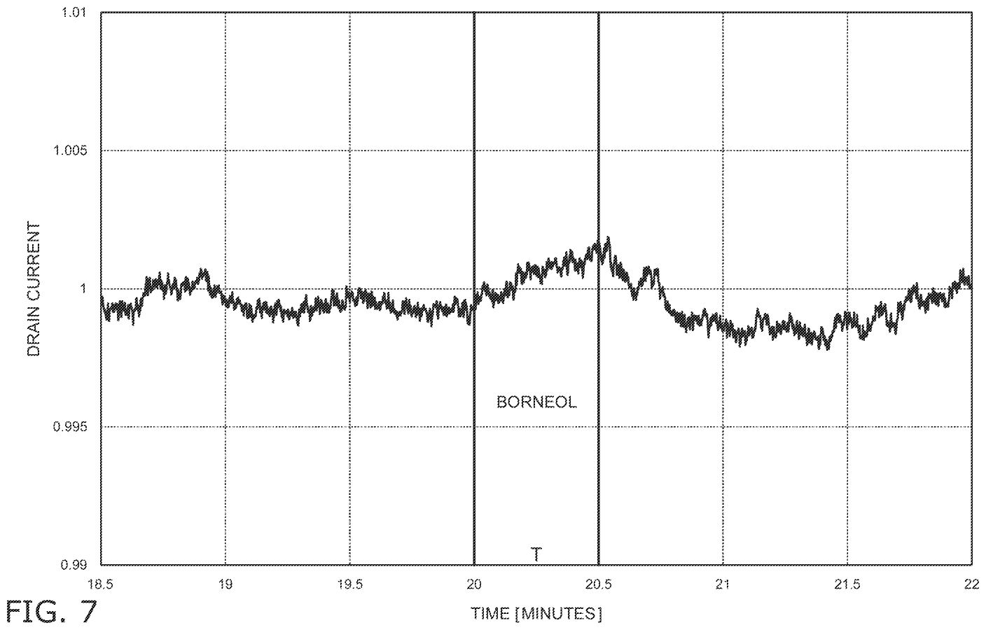

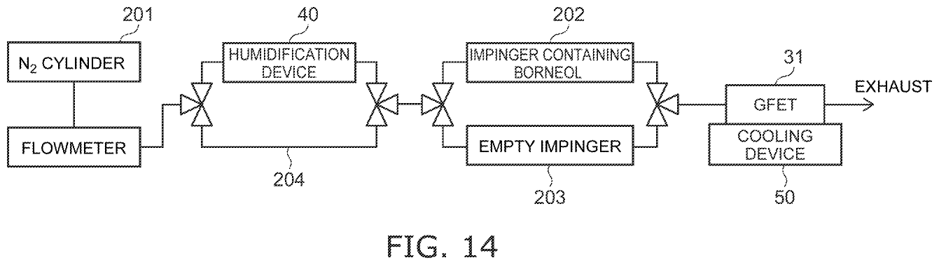

Next, in the experiment with results shown in FIG. 6 and FIG. 7, borneol was used as the target substance. The experiment used a system shown in FIG. 14. The humidification device 40 and the drying tube 204 are connected upstream of the impingers 202 and 203. During the time T, the nitrogen gas is supplied to the GFET 31 via the impinger 202 containing the borneol. FIG. 6 shows the experimental result at the room temperature, and FIG. 7 shows the experimental result when the GFET 31 is cooled by using the cooling water (pure water and ice thereof) of the cooling device 50.

In the experimental result at the room temperature in FIG. 6, a large response of the drain current is observed immediately after a flow path of the nitrogen gas is switched from the empty impinger 203 to the impinger 202 containing the borneol. It is considered that the large response is caused by the supply of the gas containing the borneol at a high concentration and filling the impinger 202 to the GFET 31. Then, although the gas containing the borneol is supplied to the GFET 31, a large response of the drain current is not observed. In addition, even when the supply of the borneol is stopped, a large response of the drain current is not observed. It is considered to be because, in a latter half of the time T, no borneol was adsorbed to the GFET 31 anyway, and therefore after the supply of the borneol is stopped, the borneol is not detached from the GFET 31.

In contrast, in the experimental result in a case of performing the cooling shown in FIG. 7, it can be seen that during the time T in which the borneol is supplied to the GFET 31, the borneol adsorbed to the GFET 31 increases, and the drain current increases. Then, since a sufficient amount of the borneol is adsorbed to the GFET 31 during the time T, the detachment of the borneol from the GFET 31 after the supply of the borneol is stopped is seen as a decrease in the drain current. That is, the detection sensitivity of the target substance can be improved by cooling the sensor element.

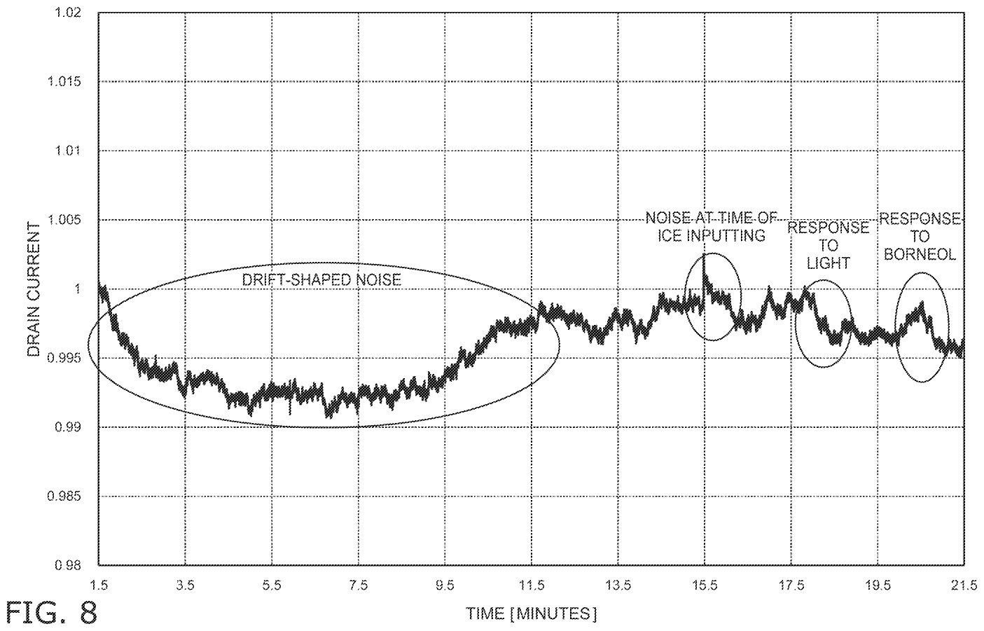

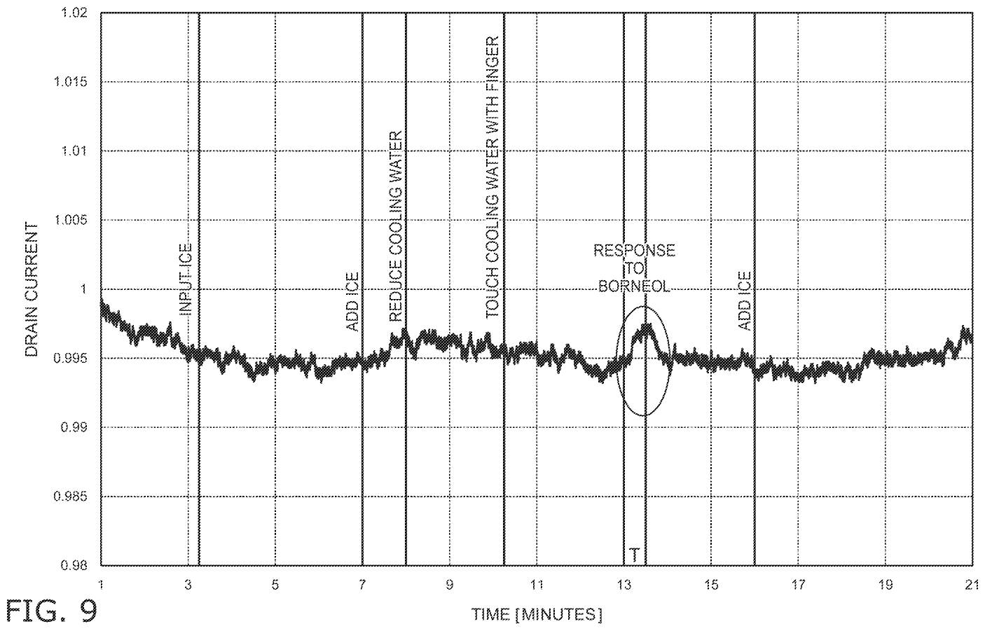

Next, in the experiment showing the results in FIG. 8 and FIG. 9, the drain current was measured by supplying the nitrogen gas containing the borneol to the GFET cooled by the cooling water. FIG. 8 shows the result when the pure water and the ice thereof are used as the cooling water and the potential of the cooling water is not fixed (the potential of the cooling water is floating). FIG. 9 shows the result when 150 mM of KCl and ice thereof are used as the cooling water and the potential (to be exact, a potential given to an Ag/AgCL electrode) of the cooling water is fixed to 0 mV by an Ag/AgCl electrode.

In the result shown in FIG. 8, drift-shaped noise and spike-shaped noise that are considered due to the potential variation of the cooling water are generated. In the result shown in FIG. 9 in which the potential of the cooling water is fixed, noise other than the response to the borneol is reduced.

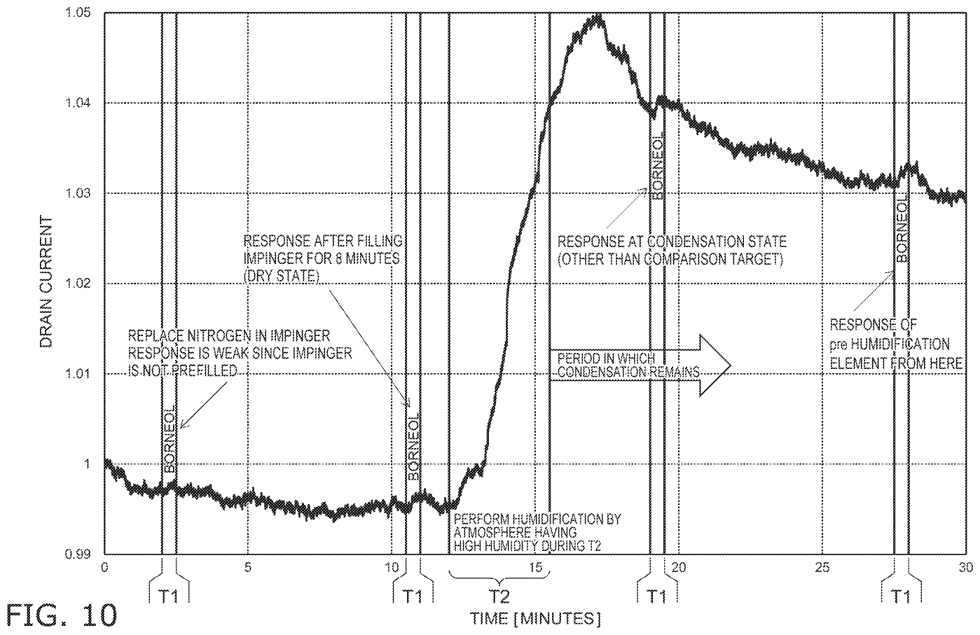

Next, in the experiments showing the results in FIG. 10 to FIG. 12, the nitrogen gas containing the borneol was supplied to the GFET during times T1, and the nitrogen gas was supplied to the GFET via the empty impinger and a humidification tube during a time T2 (humidification phase). During the humidification phase, condensation was observed on the surface of the GFET, and further, condensation remained on the surface of the GFET for several minutes after the humidification phase. The GFET is at the room temperature.

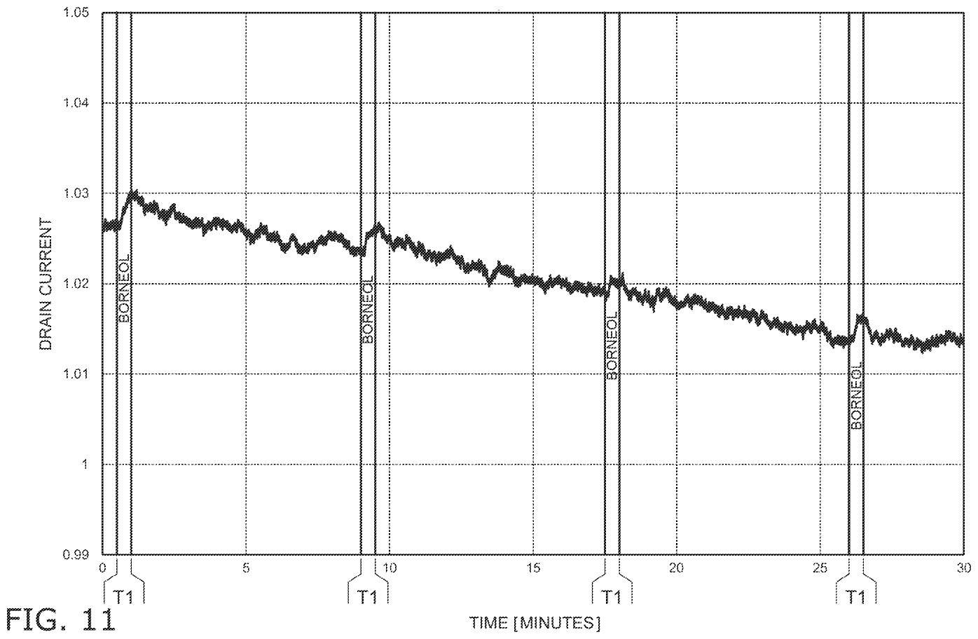

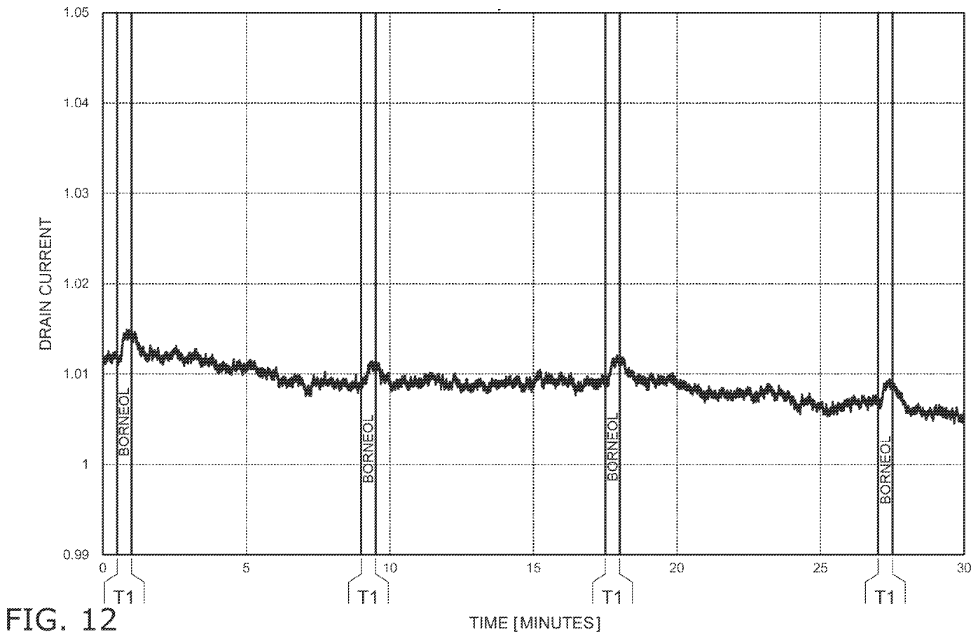

FIG. 11 shows the result obtained by measuring the drain current again after 8 minutes since the measurement of the drain current shown in FIG. 10. FIG. 12 shows the result obtained by measuring the drain current again after 4 minutes since the measurement of the drain current shown in FIG. 11.

The response of the drain current to the borneol after the humidification phase at the time T2 is larger than the response of the drain current to the borneol before the humidification phase (the surface of the GFET is in a dry state), and it is shown that the detection sensitivity of the target substance can be improved by humidifying the surface of the sensor element in advance. In addition, from the results of FIG. 11 and FIG. 12, it was confirmed that even when the condensation on the surface of the GFET was eliminated, a highly active state of the surface of the GFET was maintained, and from the experiment, it was confirmed that the highly active state was maintained for at least 1.5 hours. The highly active state is consistent with the drain current increased by the humidification being maintained in a high state. Therefore, it is also possible to determine that the high active state is maintained by using a value of the drain current.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A chemical sensor system comprising:
a chemical sensor including a sensor element and a probe molecule located on a surface of the sensor element;
a collection unit for a sample atmosphere;
a humidification device configured to generate a humidification fluid having a humidity higher than a humidity of the sample atmosphere;
a switching mechanism connected to the collection unit, the humidification device, and the chemical sensor, the switching mechanism configured to switch between a state in which the sample atmosphere is supplied to the surface of the sensor element and a state in which the humidification fluid is supplied to the surface of the sensor element; and
a cooling mechanism configured to cool the sensor element.

2. The system according to claim 1, wherein
the cooling mechanism includes a cooling pipe configured to allow a cooling water to flow therethrough.

3. The system according to claim 2, further comprising:
a non-polarizable electrode at least partially located in the cooling pipe.

4. The system according to claim 3, wherein
the cooling water containing a chlorine ion flows through the cooling pipe, and
the non-polarizable electrode is an Ag/AgCl electrode.

5. The system according to claim 1, wherein
the cooling mechanism includes a Peltier element.

6. The system according to claim 5, further comprising:
a regenerator in contact with a surface of the Peltier element.

7. The system according to claim 6, wherein
a potential of the regenerator can be fixed.

8. The system according to claim 1, wherein
the surface of the sensor element contains graphene.

9. The system according to claim 1, wherein
the probe molecule contains at least one of a protein, a peptide, an antibody, a DNA aptamer, and a derivative biomolecule thereof.

10. The system according to claim 1, further comprising:
a pipe configured to connect the collection unit and the switching mechanism;
a pipe configured to connect the humidification device and the switching mechanism; and
a pipe configured to connect the chemical sensor and the switching mechanism.

11. The system according to claim 10, further comprising:
a fan or a pump configured to cause a gas to flow from the switching device toward the chemical sensor in the pipe configured to connect the chemical sensor and the switching mechanism.

12. The system according to claim 1, wherein
the humidification fluid contains water.

13. The system according to claim 1, further comprising:
a regenerator having a fixed potential.
